(19) United States
(12) Patent Application Publication
(10) Pub. No.: US 2008/0075003 A1
(43) Pub. Date: Mar. 27, 2008

(54) METHOD AND SYSTEM FOR ADMISSION AND CONGESTION CONTROL OF NETWORK COMMUNICATION TRAFFIC

(75) Inventors: Kuo-Chun Lee, San Diego, CA (US); Mazin Al-Shalash, Frisco, TX (US); Shuqing Xing, Plano, TX (US); Jun Hu, San Diego, CA (US); Qing Lin, Shenzhen (CN); Ted Olawuyi, Allen, TX (US); Hsien Woo, San Diego, CA (US); Thawatt Gopal, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: FutureWei Technologies, Inc., Plano, TX (US)

(21) Appl. No.: 11/857,853

(22) Filed: Sep. 19, 2007

Related U.S. Application Data
(60) Provisional application No. 60/846,448, filed on Sep. 21, 2006.

(51) Int. Cl. G06F 11/00; H04L 12/56

(52) U.S. Cl. 370/230; 370/232; 370/235; 370/345; 370/412

(57) ABSTRACT

A method for controlling communications traffic on an inter-access-network link includes receiving a request for transmission of a traffic flow and determining a priority queue associated with the traffic flow. If the priority queue corresponds to the one of a first plurality of priority levels, the method further includes determining whether one or more predetermined criteria for the traffic flow are satisfied. If yes, the method additionally admitting the traffic flow, storing information associated with the traffic flow in the queue, and transmitting information associated with the traffic flow from the queue based on at least a strict priority process. If the queue corresponds to the one of a second plurality of priority levels, the method further admitting the traffic flow, storing information associated with the traffic flow in the queue, and transmitting information associated with the traffic flow from the queue based on at least an arbitrated priority process.

### CROSS-REFERENCES TO RELATED APPLICATIONS

This application claims priority to U.S. Provisional Patent Application No. 60/846,448, filed on Sep. 21, 2006, commonly assigned, incorporated by reference herein for all purposes.

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

Embodiments of the present invention are directed to a communication technology for handling communications traffic. More particularly, the invention provides a method and system of admission control and congestion control of communications traffic on the inter-access-network link with limited bandwidth. Merely by way of example, the invention has been applied on third generation (3G) Code Division Multiple Access (CDMA) wireless high rate packet data interface standard such as CDMA2000 1x RTT, EV-DO, or EV-DV. It also can be applied to other telecommunication networks beyond 3G, such as ones with similar topology and services for data and/or voice transmissions.

Code Division Multiple Access (CDMA) is a form of multiplexing (not a modulation scheme) and a method of multiple access that does not divide up the channel by time as in time division multiple access (TDMA), or frequency as in frequency-division multiple access (FDMA), but instead encodes data with a special code associated with each channel and uses the constructive interference properties of the special codes to perform the multiplexing. Particularly, CDMA refers to digital cellular telephony systems that make use of this multiple access scheme. For example, in metropolitan areas, several data-optimized access networks (DO AN's) or 1x base station subsystems (1x BSS's) or cell sites can be deployed. When any mobile station such as a CDMA phone is moving across AN (or BSS for GSM network) boundary, a radio link with a first AN or BSS is required not to break before a new link with a second AN or BSS is established. Therefore, an inter-access-network (inter-AN) or inter-BSS soft handoff is needed.

FIG. 1 is a simplified diagram illustrating examples of conventional inter-AN soft handoff. In one example, one access terminal AT2, which represents a subscribed mobile station in the network, is anchored at AN2 and just moves to AN1. AT2 has two Reverse Link (RL) soft handoff legs via two Base Transceiver Stations, BTS2 and BTS3, and one Forward Link (FL) soft handoff leg via BTS2. For one RL leg and one FL leg, the soft handoff is performed on an inter-access-network link between an Access Network Controller (ANC) or Base Station Controller (BSC) for AN2 and another ANC or BSC for AN1. This link provides a channel for inter-AN soft handoff traffic and is referred to an inter-ANC/BSC link. AT2 has another RL leg via BTS3 that does not use the inter-AN/BSS link. In another example, AT1 is anchored at AN1 and has moved to inner sectors of AN2. AT1 has two RL legs and one FL leg that all use the inter-AN/BSS link.

The inter-AN/BSS soft handoff may include one or more flows of traffic such as data and voice coded in various packets that are required to be transmitted through the inter-AN/BSS link. However, the inter-AN/BSS link has limited bandwidth and therefore admission and congestion control is required to ensure service quality. In the past, admission control does not consider Quality of Service (QoS) for wireless multi-media or inter-AN/BSS soft handoff applications.

From the above, it is seen that an improved technique of admission and congestion control with quality of service for inter-AN/BSS soft handoff in telecommunication networks is desired.

### BRIEF SUMMARY OF THE INVENTION

Embodiments of the present invention are directed to a communication technology for handling communications traffic. More particularly, the invention provides a method and system of admission control and congestion control of communications traffic on the inter-access-network link with limited bandwidth. Merely by way of example, the invention has been applied on third generation (3G) Code Division Multiple Access (CDMA) wireless high rate packet data interface standard such as CDMA2000 1x RTT, EV-DO, or EV-DV. It also can be applied to other telecommunication networks, such as ones with similar topology and services for data and/or voice transmissions.

In a specific embodiment, the invention provides a method for controlling communications traffic on an inter-access-network (inter-AN) link. The method includes receiving a request for transmission of a traffic flow through an inter-AN link between a first access network controller and a second access network controller. Additionally the method includes determining a priority queue associated with the traffic flow. The priority queue corresponds to either one of a first plurality of priority levels or one of a second plurality of priority levels. Each of the first plurality of priority levels is higher than each of the second plurality of priority levels. Moreover, if the priority queue corresponds to the one of the first plurality of priority levels, the method includes determining whether one or more predetermined criteria for the traffic flow is satisfied. If the one or more predetermined criteria is satisfied, the method further includes admitting the traffic flow, storing information associated with the traffic flow in the queue, and transmitting information associated with the traffic flow from the queue based on at least a strict priority process. If the queue corresponds to the one of the second plurality of priority levels, the method further includes admitting the traffic flow, storing information associated with the traffic flow in the queue, and transmitting information associated with the traffic flow from the queue based on at least an arbitrated priority process. In the following, we simply denote inter-AN link as various kinds of inter-access-network links. Occasionally it is also referred as inter-ANC link for inter-access-network-controller link or inter-BSC link for inter-base-station-controller link.

In another specific embodiment, the invention provides a method of controlling communications traffic on an inter-AN link. The method includes receiving a request for transmission of a first plurality of traffic flows through an inter-AN link from a first network controller to a second network controller. The method further including grouping first plurality of traffic flows into at least a second plurality of traffic flows and a third plurality of traffic flows. The second plurality of traffic flows is associated with a first group of queues corresponding to a first plurality of priority levels respectively. The third plurality of traffic flows is associated with a second group of queues corresponding to a second plurality of priority levels respectively. Each of the first plurality of priority levels is higher than each of the second plurality of priority levels. Additionally, the method includes determining whether one or more predetermined criteria are satisfied for the first plurality of traffic flows. If the one or more predetermined criteria are determined to be satisfied for the first plurality of traffic flows, the method further includes admitting the first plurality of traffic flows, storing information associated with the second plurality of traffic flows in the first group of queues, and storing information associated with the third plurality of traffic flows in the second group of queues; moreover, the method includes transmitting information associated with the second plurality of traffic flows from the first group of queues based on at least a strict priority process and transmitting information associated with the third plurality of traffic flows from the second group of queues based on at least an arbitrated priority process.

In an embodiment, the method of determining whether one or more predetermined criteria are satisfied for the first plurality of traffic flows includes determining whether the one or more predetermined criteria are satisfied for the second plurality of traffic flows. If the one or more predetermined criteria are determined to be satisfied for the second plurality of traffic flows, the method determines that the one or more predetermined criteria are satisfied for the first plurality of traffic flows.

In another embodiment, the method of determining whether the one or more predetermined criteria are satisfied for the second plurality of traffic flows further includes determining whether corresponding one of the one or more predetermined criteria is satisfied for each of the second plurality of traffic flows. Only if the corresponding one of the one or more predetermined criteria is determined to be satisfied for each of the second plurality of traffic flows, the method determines that the one or more predetermined criteria are satisfied for the second plurality of traffic flows.

In yet another specific embodiment, the invention provides a method for controlling admission of communications traffic to an inter-AN link. The method includes receiving a request for transmission of one or more traffic flows through an inter-AN link between a first network controller and a second network controller. The one or more traffic flows includes a first traffic flow corresponding to a first category of traffic selected from a plurality of categories of traffics. Additionally, the method includes processing information associated with the first category of traffic and determining a first predicted link utilization for the first category of traffic on the inter-AN link. The method further includes processing information associated with the first predicted link utilization and determining whether the first category of traffic satisfies one or more first criteria based on at least information associated with the first predicted link utilization. Moreover, the method includes rejecting the one or more traffic flows if the first category of traffic is determined not to satisfy the one or more first criteria.

In yet still another specific embodiment, the invention provides a method for controlling congestion of communications traffic on an inter-AN link. The method includes admitting at least one traffic flow for transmission on an inter-AN link from a first access network controller to a second access network controller. The traffic flow is transmitted from a priority queue. The method further includes determining a queue length for the priority queue on the inter-AN link and processing information associated with the queue length. Additionally, the method includes determining whether the priority queue is in a congestion state based on at least information associated with the queue length. If the priority queue is determined in the congestion state, the method includes determining one or more traffic flows sent from one or more sources to the priority queue at one or more data rates respectively. The method further includes sending a congestion indication message for the priority queue to the one or more sources.

According to an alternative embodiment, the invention provides a system for controlling communications traffic on an inter-AN link. The system includes a network controller component that is configured to receive a request for transmission of a traffic flow through an inter-AN link and determine a priority queue associated with the traffic flow. The priority queue corresponds to either one of a first plurality of priority levels or one of a second plurality of priority levels. Each of the first plurality of priority levels is higher than each of the second plurality of priority levels. If the priority queue corresponds to the one of the first plurality of priority levels, the network controller component is further configured to determine whether one or more predetermined criteria for the traffic flow is satisfied. If the one or more predetermined criteria is satisfied, the network controller component further is configured to admit the traffic flow, store information associated with the traffic flow in the queue, and transmit information associated with the traffic flow from the queue based on at least a strict priority process. If the priority queue corresponds to the one of the second plurality of priority levels, the network controller component further is configured to admit the traffic flow, store information associated with the traffic flow in the queue, and transmit information associated with the traffic flow from the queue based on at least an arbitrated priority process.

According to another embodiment, the invention provides a system of controlling communications traffic on an inter-AN link. The system includes a network controller component configured to receive a request for transmission of a first plurality of traffic flows through an inter-AN link and group the first plurality of traffic flows into at least a second plurality of traffic flows and a third plurality of traffic flows. The second plurality of traffic flows is associated with a first group of queues corresponding to a first plurality of priority levels respectively and the third plurality of traffic flows is associated with a second group of queues corresponding to a second plurality of priority levels respectively. Each of the first plurality of priority levels is higher than each of the second plurality of priority levels. additionally, the network controller component is configured to determine whether one or more predetermined criteria are satisfied for the first plurality of traffic flows satisfies. If the one or more predetermined criteria are satisfied, the network controller component is configured to admit the first plurality of traffic flows, store information associated with the second plurality of traffic flows in the first group of queues, and store information associated with the third plurality of traffic flows in the second group of queues. Moreover, the network controller component is configured to transmit information associated with the second plurality of traffic flows from the first group of queues based on at least a strict priority process and transmit information associated with the third plurality of traffic flows from the second group of queues based on at least an arbitrated priority process.

According to yet another embodiment, the invention provides a system for controlling admission of communications traffic to an inter-AN link. The system includes a network controller component configured to receive a request for transmission of one or more traffic flows through an inter-AN link. The one or more traffic flows includes a first traffic flow corresponding to a first category of traffic selected from a plurality of categories of traffics. The network controller component processes information associated with the first category of traffic and determines a first predicted link utilization for the first category of traffic on the inter-AN link. Additionally, the network controller component processes information associated with the first predicted link utilization and determines whether the first category of traffic satisfies one or more first criteria based on at least information associated with the first predicted link utilization. The network controller component further is configured to reject the one or more traffic flows if the first category of traffic is determined not to satisfy the one or more first criteria.

According to yet still another embodiment, the invention provides a system for controlling congestion of communications traffic on an inter-AN link. The system includes a network controller component configured to admit at least one traffic flow for transmission on an inter-AN link, the traffic flow being transmitted from a priority queue and determine a queue length for the priority queue on the inter-AN link. The network controller component processes information associated with the queue length and determines whether the priority queue is in a congestion state based on at least information associated with the queue length. If the priority queue is determined in the congestion state, the network controller component determines one or more traffic flows sent from one or more sources to the priority queue at one or more data rates respectively and send a congestion indication message to the one or more sources; otherwise, the network controller component sends no congestion indication message. The system further includes an internal data processing unit (DPU) configured to reduce the one or more data rates for the one or more traffic flows sent to the priority queue iteratively per a first time period from an initial level in response to the congestion indicate message for the priority queue sent from the network controller component. The DPU board may increase the one or more data rates iteratively back to initial levels after a second time period without receiving the congestion indicate message for the priority queue. The second time period is longer than the first time period.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram illustrating an example of conventional inter-AN soft handoff;

FIG. 2 is a flowchart illustrating a method for controlling communications traffic through an inter-AN link according to an embodiment of the present invention;

FIG. 3 is a flowchart illustrating a method for controlling communications traffic through an inter-AN link according to another embodiment of the present invention;

FIG. 4 is a simplified diagram illustrating a structure of eight classes of priority queues each having a corresponding DSCP value of IP packets supported by an inter-ANC/BSC interface according to an embodiment of the present invention;

FIG. 5 is a table showing examples of the design of the DSCP values for a list of traffic flow applications of inter-AN soft handoff each having a corresponding priority queue class defined in FIG. 4 according to an embodiment of present invention;

FIG. 6 is a flowchart illustrating a method for controlling admission of communications traffic into an inter-AN link according to an embodiment of the present invention;

FIG. 7A is a table showing exemplary lists of flow applications of inter-AN soft handoff and corresponding priority queue classes according to an embodiment of the present invention;

FIG. 7B is a table showing exemplary admission criteria of corresponding traffic categories for a list of inter-AN soft handoff traffic flow applications shown in FIG. 7A according to an embodiment of the present invention;

FIG. 8 is a flowchart illustrating a method for controlling congestion of communications traffic on an inter-AN link according to an embodiment of the present invention;

FIG. 9A is a table showing examples of a list of traffic flow applications subject to congestion control and the corresponding congestion conditions for each queue class according to an embodiment of the present invention;

FIG. 9B is a table showing an example of information elements of a congestion indication message sent by an inter-ANC/BSC interface to a source of one or more traffic flows according to an embodiment of the present invention;

FIG. 10A is a simplified diagram illustrating a case of DO inter-ANC soft handoff in which admission controls may be triggered between a source ANC and a target ANC according to an embodiment of the present invention;

FIG. 10B is a simplified diagram illustrating a case of 1x inter-BSC soft handoff in which admission controls may be triggered between a source BSC and a target BSC according to an embodiment of the present invention;

FIG. 10C is a simplified diagram illustrating a case of adding a new flow to an existing DO inter-ANC soft handoff in which admission controls may be triggered between a source ANC and a target ANC according to an embodiment of the present invention.

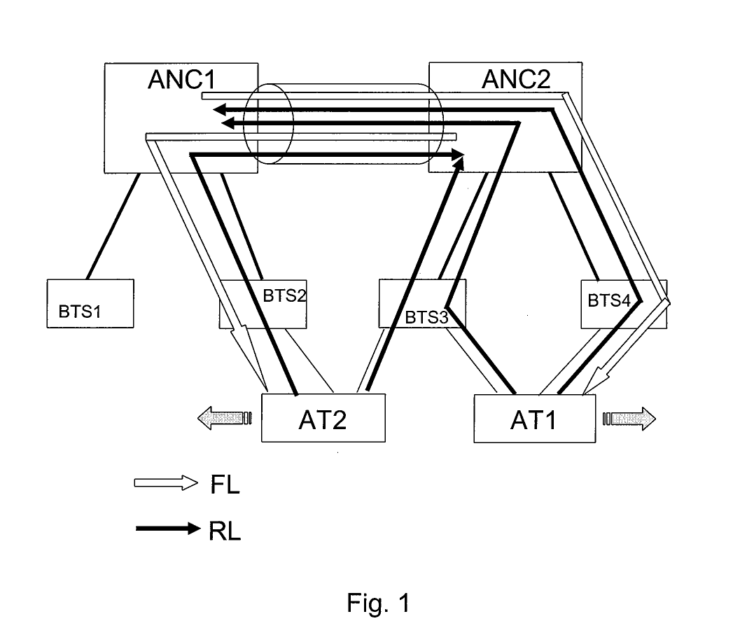

### DETAILED DESCRIPTION OF THE INVENTION

Embodiments of the present invention are directed to a communication technology for handling communications traffic. More particularly, the invention provides a method and system of admission control and congestion control of communications traffic on the inter-access-network link with limited bandwidth. Merely by way of example, the invention has been applied on third generation (3G) Code Division Multiple Access (CDMA) wireless high rate packet data interface standard such as CDMA2000 1x RTT, EV-DO, or EV-DV. It also can be applied to other telecommunication networks, such as ones with similar topology and services for data and/or voice transmissions.

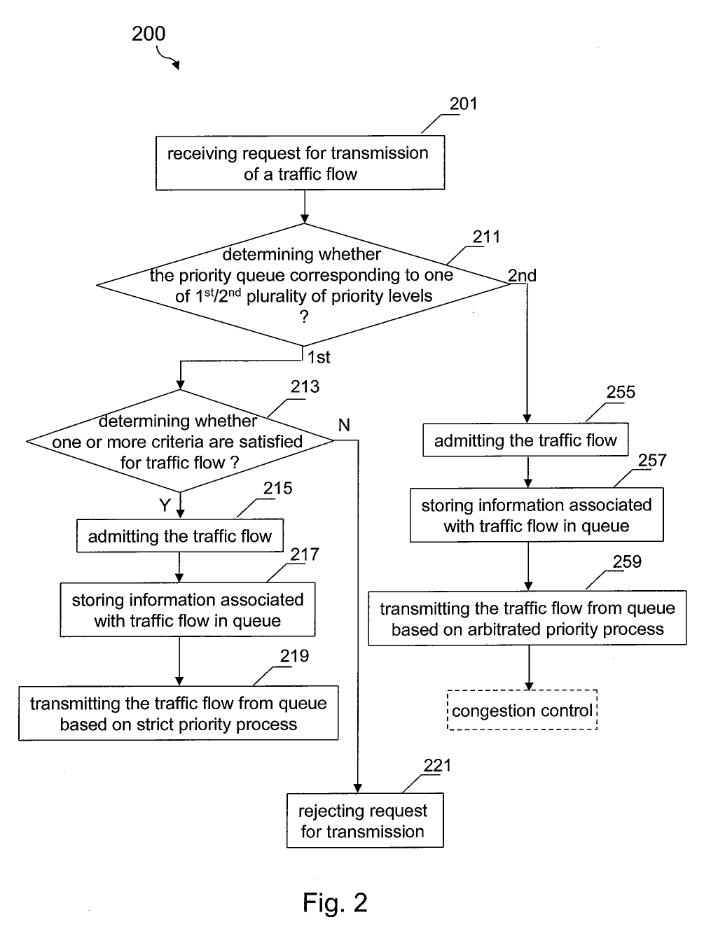

FIG. 2 is a flowchart illustrating a method for controlling communications traffic through an inter-AN link according to an embodiment of the present invention. This diagram is merely an example, which should not unduly limit the scope of the claims herein. The method 200 includes the following processes:

1. Process 201 for receiving a request for transmission of a traffic flow through an inter-AN link;

2. Process 211 for determining a priority queue associated with the traffic flow, if the queue corresponds to one of a first plurality of priority levels, moving to process 213, if the queue corresponds to one of a second plurality of priority levels, moving to process 255;

3. Process 213 for determining whether one or more criteria are satisfied for the traffic flow; if yes, moving to process 215, if not, moving to process 221;

4. Process 215 for admitting the traffic flow;

5. Process 217 for storing information associated with the traffic flow in the priority queue;

6. Process 219 for transmitting the traffic flow from the queue based on at least a strict priority process;

7. Process 255 for admitting the traffic flow;

8. Process 257 for storing information associated with the traffic flow in the priority queue;

9. Process 259 for transmitting the traffic flow from the queue based on at least an arbitrated priority process;

10. Process 221 for rejecting the request for transmission.

The above sequence of processes provides a method according to an embodiment of the present invention. Other alternatives can also be provided where processes are added, one or more processes removed, or one or more processes are provided in a different sequence without departing from the scope of the claims herein. Further detail of the present invention can be found throughout the present specification and more particularly below.

At the process 201, a request for transmission of a communication traffic flow through an inter-AN link from a source of traffic is received by an access network controller (ANC) component including an inter-AN interface board. In one embodiment, the request for transmission is associated with an inter-AN soft handoff. For example, the traffic flow to be transmitted may be an IP data packet related to data or voice applications. In another embodiment, the request for transmission of the traffic flow may be a forward link transmission from a source ANC or a source base station controller (BSC) to a target ANC or target BSC. In yet another embodiment, the request for transmission may be a reverse link transmission from a target ANC/BSC to a source ANC/BSC. In another specific embodiment, the traffic flow to be transmitted may be a new flow added to an existing inter-ANC soft handoff.

At the process 211, a priority queue associated with the traffic flow is determined. In one embodiment, the inter-AN interface board can support plurality of priority queues associated with the incoming traffic flows to allow transmission priority for these traffic flows. For example, an inter-ANC/BSC interface board capable of providing quality of service (QoS) for the traffic flows on the link can support eight priority queues. Each priority queue is a data structure set to accept some DSCP (differentiated Service Code Point) values of IP packets, which represent a corresponding priority level. Technically, the plurality of priority queues can be classified to a first group having a first plurality of priority levels and a second group having a second plurality of priority levels. At the process 211, if the method 200 determines that the queue associated with the traffic flow requested for transmission corresponds to one of the first plurality of priority levels, the method 200 forwards to a process 213. If in the process 211 the method 200 determines that the queue associated with the traffic flow requested for transmission corresponds to one of the second plurality of priority levels, the method 200 forwards to a process 255.

If the traffic flow is determined to be associated with a priority queue that corresponds to a first plurality of priority levels as in the process 211, the request for transmission of the traffic flow over the inter-AN link may be subject to admission control. At process 213, the method 200 is to determine whether one or more criteria can be satisfied for the traffic flow to be admitted. In one embodiment, the one or more criteria can be predetermined or modified depending on the network design or type of service or particular link utilization by specific local traffic flows. In another embodiment, the criteria may be differentiated for different priority levels of the priority queues and application types of the traffic flows. In a specific embodiment, the one or more criteria are related to a predicted link utilization for the outbound transmission on the inter-AN link. More details can be found in this specification of several specific embodiments of the present invention described in later sections.

At the process 215, once the one or more predetermined criteria are determined to be satisfied for the traffic flow, the traffic flow is admitted for transmission through the inter-AN link.

At the process 217, information associated with the traffic flow is stored in the priority queue determined earlier in process 211. In one embodiment, storing information associated with the traffic flow in the queue is performed by a first network controller. For example, the first network controller is a source ANC/BSC for forward link transmission. In another example, the first network controller is a target ANC/BSC for reverse link transmission.

At the process 219, the traffic flow is transmitted from the queue to a second network controller based on at least a strict priority process. At the process 211, the priority queue has been determined to corresponds to one of the first plurality of priority levels. The priority levels are classified to different levels strictly from high to low. For example, the traffic flow may be an 1x data application which is associated with a priority level Q3. In another example, the traffic flow may be an 1x voice application which is associated with a priority level Q1, the priority level Q1 is higher than the priority level Q3. In one embodiment, the strict priority process is a transmission scheduling scheme for corresponding queue on the inter-AN link in a strict transmission order with descending priority level from a highest level to a lowest level. In the example mentioned above, the traffic flow with priority level Q1, once admitted, will be allowed for transmission before another traffic flow with priority level Q3 on the same inter-AN link. Of course, other queuing process such as custom queuing can be used. One of ordinary skilled in the art would recognize many alternatives, variations, and modifications.

Alternatively, referring back to FIG. 2, if the traffic flow is determined to be associated with a priority queue that corresponds to a second plurality of priority levels as in the process 211, the method 200 moves to execute process 255. In one embodiment, the second plurality of priority levels is defined such that each of the second plurality of priority levels is lower than each of the first plurality of priority levels. In another embodiment, the request for transmission of the traffic flow having a queue associated with one of the second plurality of priority levels is not subject to admission control. In other words, at process 255, the method 200 is to admit the traffic flow without performing admission criteria check.

Subsequently, at the processes 257, the information associated with the traffic flow is stored in the priority queue, then at the process 259 is transmitted via the queue from a first network controller to a second network controller based on an arbitrated priority process. In one embodiment, the arbitrated priority process is a transmission scheduling scheme for the queue on the inter-AN link with a corresponding allocation of transmission time determined by a best-effort scheduling algorithm. For example, the best-effort scheduling algorithm includes Weighted Round Robin. In another embodiment, other queuing algorithms such as FIFO, weighted fair queuing, or class-based weighted round robin may be used. In yet another embodiment, the traffic flow stored in and transmitted from such a best-effort priority queue may be subject to congestion control, where the data rate within the allocated transmission time is adjustable based on whether the queue is in a congestion state or not. More details of certain embodiments of the present invention regarding to the congestion control can be found in later sections of the specification.

At process 221, if one or more (admission) criteria are not satisfied for the traffic flow, the method 200 is to reject the request for transmission. By setting certain criteria and rejecting certain communications traffic into the inter-AN link if the criteria are not satisfied, the inter-AN link, usually with limited bandwidth, can provide guaranteed QoS for the existing traffic flows on the link.

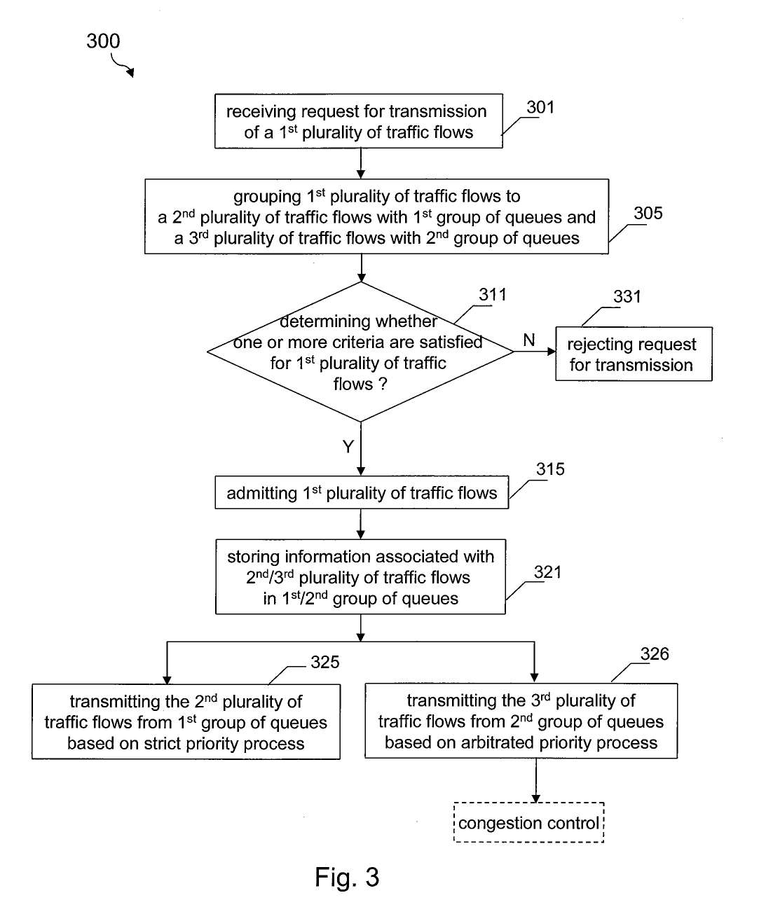

FIG. 3 is a flowchart illustrating a method for controlling communications traffic through an inter-AN link according to another embodiment of the present invention. This diagram is merely an example, which should not unduly limit the scope of the claims herein. The method 300 includes the following processes:

1. Process 301 for receiving a request for transmission of a first plurality of traffic flows through an inter-AN link;

2. Process 305 for grouping the first plurality of traffic flows to at least a second plurality of traffic flows associated with a first group of priority queues and a third plurality of traffic flows associated with a second group of priority queues;

3. Process 311 for determining whether one or more criteria are satisfied for the first plurality of traffic flows, if yes, moving to process 315, otherwise, moving to process 331;

4. Process 315 for admitting the first plurality of traffic flows;

5. Process 321 for storing information associated with the second plurality of traffic flows in the first group of priority queues and storing information associated with the third plurality of traffic flows in the second group of priority queues;

6. Process 325 for transmitting the second plurality of traffic flows from the first group of queues based on at least a strict priority process;

7. Process 326 for transmitting the third plurality of traffic flows from the second group of queues based on at least an arbitrated priority process;

8. Process 331 for rejecting the request for transmission.

The above sequence of processes provides a method according to an embodiment of the present invention. Other alternatives can also be provided where processes are added, one or more processes removed, or one or more processes are provided in a different sequence without departing from the scope of the claims herein. Further detail of the present invention can be found throughout the present specification and more particularly below.

At the process 301, a request for transmission of a first plurality of traffic flows through an inter-AN link from a source of traffic is received by an access network controller (ANC) component including an inter-AN interface board. In one embodiment, the request for transmission is associated with an inter-ANC/BSC soft handoff. For example, the plurality of traffic flows to be transmitted may be IP data packets related to data or voice applications. In another embodiment, the request for transmission of the traffic flow may be a forward link transmission from a source ANC or a source base station controller (BSC) to a target ANC or target BSC. In yet another embodiment, the request for transmission may be a reverse link transmission from a target ANC/BSC to a source ANC/BSC.

At the process 305, the method 300 is to group the first plurality of traffic flows to at least a second plurality of traffic flows and a third plurality of traffic flows based on the classification of priority queues associated with the traffic flows. The priority queues are buffer data structures for storing information associated with the traffic flows. In one embodiment, the second plurality of traffic flows is associated with a first group of plurality of priority queues and the third plurality of traffic flows is associated with a second plurality of priority queues. In another embodiment, each of the first group of priority queues has a higher priority level than each of the second group of priority queues.

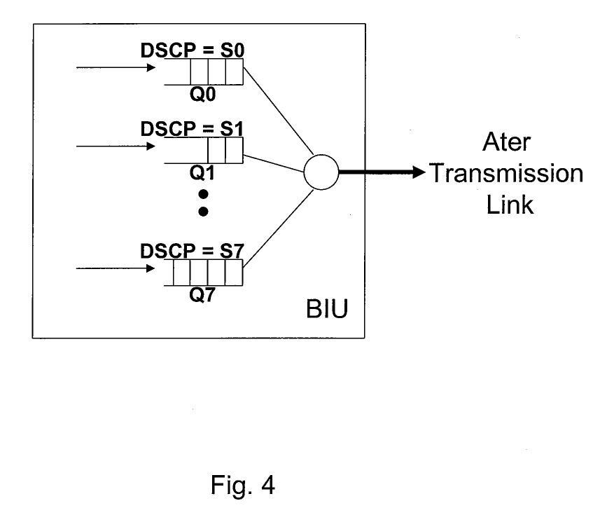

For example, the inter-ANC/BSC interface board may support eight priority queues allowing transmission priority control. Each priority queue is set to accept some DSCP values of IP packets. FIG. 4 is a simplified diagram illustrating a structure of eight classes of priority queues each having a corresponding DSCP value of IP packets supported by an inter-ANC/BSC interface according to an embodiment of the present invention. This diagram is merely an example, which should not unduly limit the scope of the claims herein. One of ordinary skilled in the art would recognize many alternatives, variations, and modifications. As shown in FIG. 4, a first priority queue is represented by Q0. Sequentially, seven other priority queues are represented by Q1, . . . Q7. Q0 may have a highest priority level and Q7 may have a lowest priority level. Si, i=0, 1, 7 mean the set of DSCP values of which the IP packets are buffered in the corresponding priority queue Qi. All these priority queues are waited, subject to certain admission control, to be transmitted into the inter-AN link, and may be subject to congestion control afterwards.

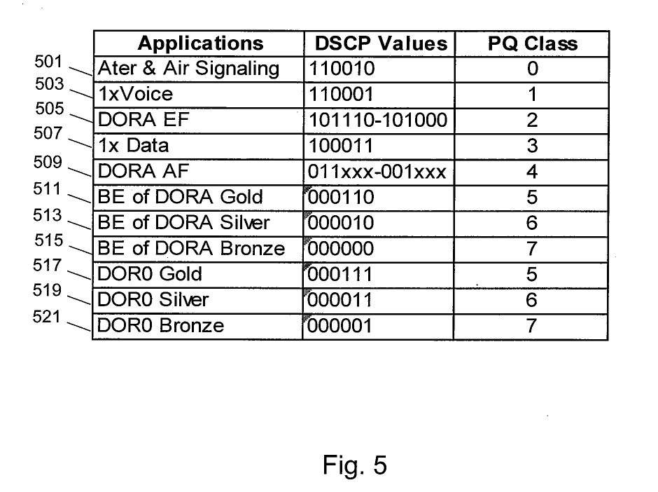

FIG. 5 is a table showing an example of the design of the DSCP values for a list of traffic flow applications of inter-AN soft handoff each having a corresponding priority queue class defined in FIG. 4 according to an embodiment of present invention. This diagram is merely an example, which should not unduly limit the scope of the claims herein. One of ordinary skilled in the art would recognize many alternatives, variations, and modifications. For example, the second plurality of traffic flows may include Ater & Air Signaling, 1x Voice traffic, DORA EF type traffic, 1x Data traffic, and DORA AF type traffic and be associated with the first five priority queues, i.e., Q0 to Q4, on the list shown in FIG. 5, which have mid to high priority levels. The third plurality of traffic flows may include all BE type traffic and DORO traffic and be associated with the last three priority queues, from Q5 to Q7, which have low priority levels.

Referring back to FIG. 3, at the process 311, the method 300 is to determine whether one or more criteria are satisfied for the first plurality of traffic flows. In one embodiment, if the one or more predetermined criteria are determined to be satisfied for the second plurality of traffic flows, the method 300 determines that the one or more predetermined criteria are satisfied for the first plurality of traffic flows. In another embodiment, only if the corresponding one of the one or more predetermined criteria is determined to be satisfied for each of the second plurality of traffic flows, the method 300 determines that the one or more predetermined criteria are satisfied for the second plurality of traffic flows. For example, as a new inter-AN soft handoff is received by a first access network controller, if one or more traffic flows of the inter-AN soft handoff are determined to be associated with priority queues belonging to Q0 to Q4, each of the one or more traffic flows is subject the admission control. In other words, one or more predetermined criteria are to be verified for each of the one or more traffic flows. However, if some traffic flows are associated with priority queues belonging to Q1 to Q4 and other are associated with priority queues belonging to Q5 to Q7, only the traffic flows associated with Q1 to Q4 queues are subject to admission control. Note, the traffic flow with priority queue Q0 typically is for the network transmission signaling which is not subject to the admission control.

At the process 315, the first plurality of traffic flows is admitted by the inter-AN interface board if one or more predetermined criteria are satisfied. For example, each of the one or more traffic flows within the first plurality of traffic flows associated with Q1 to Q4 priority queues has been determined to meet the one or more predetermined criteria, then all traffic flows, including the traffic flows associated with Q5 to Q7 priority queues, are admitted. Otherwise, if any one flow belonging to one of priority queues Q1 to Q4 is determined to not meet the one or more criteria, then the method 300 is to perform process 331, i.e., to reject all traffic flows associated with the request.

At the process 321, the method 300 is to store information associated with the second plurality of traffic flows in the first group of queues and store information associated with the third plurality of traffic flows in the second group of queues. For example, the second plurality of traffic flows are stored in one or more priority queues Q1 to Q4 and the third plurality of traffic flows are stored in one or more priority queues Q5 to Q7. In one embodiment, storing information associated with the first plurality of traffic flows in the corresponding queues is performed by a first network controller. For example, the first access network controller is a source ANC/BSC for forward link transmission. In another example, the first network controller is a target ANC/BSC for reverse link transmission.

At the process 325 and 326, the method 300 respectively performs transmitting the traffic flows on the inter-AN link based on certain transmission scheduling processes. Particularly on the one hand at the process 325, the second plurality of traffic flows is transmitted from the first group of priority queues based on at least a strict priority process. For example, the first group of priority queues includes five queues from Q0 to Q4. The Q0 has a highest priority level and sequentially Q1 to Q4 has lower and lower priority level. In one embodiment, the strict priority process is a transmission scheduling scheme for corresponding queue on the inter-AN link in a strict transmission order with descending priority level from a highest level to a lowest level. For example, any flow associated with a highest priority level queue will be transmitted with full guaranteed QoS on the inter-AN link. The flow associated with second highest priority level will be transmitted next, and so on. At any time period, one flow among the second plurality of traffic flows, once admitted, is being transmitted with full guarantee of QoS.

On the other hand at the process 326, the third plurality of traffic flows is transmitted from the second group of priority queues based on at least an arbitrated priority process. For example, the second group of priority queues includes three queues from Q5 to Q7. In one embodiment, the arbitrated priority process is a transmission scheduling scheme for the queue on the inter-AN link with a corresponding allocation of transmission time determined by a best-effort scheduling algorithm. For example, the Q5-Q7 are scheduled using a best-effort scheduling algorithm including Weighted Round Robin (WRR). In another embodiment, other queuing algorithms such as first-in-first-out (FIFO), weighted fair queuing, or class-based weighted round robin may be used. Additionally in one embodiment, the third plurality of traffic flows is transmitted on the inter-AN link without fully guarantee of QoS. In other words, the third plurality of traffic flows may be transmitted with adjustable data rate subject to certain criteria of congestion control of corresponding queues on the inter-AN link. Certain embodiments of the present invention provide more details of handling the congestion control of the third plurality of traffic flows as described in specification below.

Certain embodiments of the present invention provide a method for controlling admission of communications traffic into an inter-AN link. The method includes receiving a request for transmission of one or more traffic flows through an inter-AN link between a first network controller and a second network controller. The one or more traffic flows includes a first traffic flow corresponding to a first category of traffic selected from a plurality of categories of traffics. Additionally, the method includes processing information associated with the first category of traffic and determining a first predicted link utilization for the first category of traffic on the inter-AN link. The method further includes processing information associated with the first predicted link utilization and determining whether the first category of traffic satisfies one or more first criteria based on at least information associated with the first predicted link utilization. Moreover, the method includes rejecting the one or more traffic flows if the first category of traffic is determined not to satisfy the one or more first criteria.

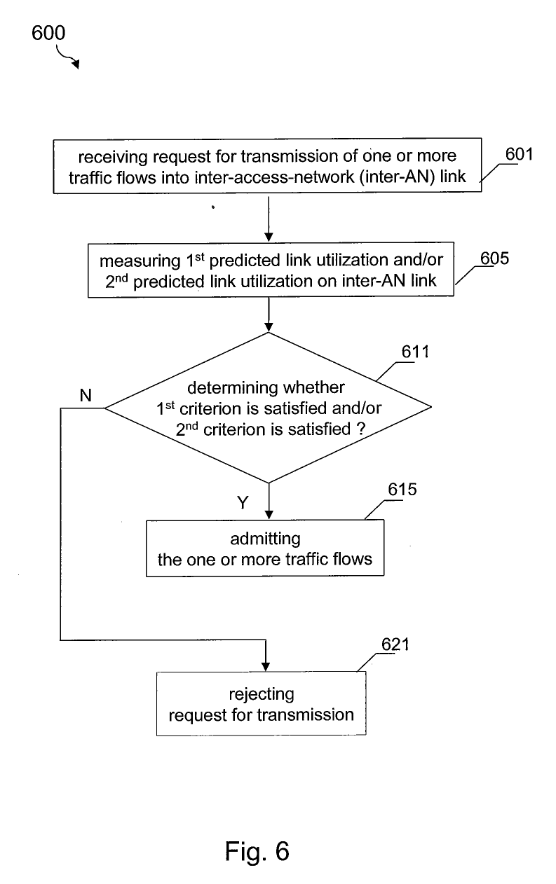

FIG. 6 is a flowchart illustrating a method for controlling admission of communications traffic into an inter-AN link according to an embodiment of the present invention. This diagram is merely an example, which should not unduly limit the scope of the claims herein. The method 600 includes the following processes:

1. Process 601 for receiving a request for transmission of one or more traffic flows through an inter-AN link;

2. Process 605 for measuring a first predicted link utilization and a second predicted link utilization on the inter-AN link;

3. Process 611 for determining whether one or more criteria is satisfied;

4. Process 615 for admitting the one or more traffic flows if yes at the process 611; and

5. Process 621 for rejecting the request for transmission if no at the process 611.

The above sequence of processes provides a method according to an embodiment of the present invention. Other alternatives can also be provided where processes are added, one or more processes removed, or one or more processes are provided in a different sequence without departing from the scope of the claims herein. Further detail of the present invention can be found throughout the present specification and more particularly below.

At the process 601, a request for transmission of one or more traffic flows through the inter-AN link from a source of traffic is received by an ANC component including an the inter-AN interface board. For example, the request for transmission of the one or more traffic flows is an inter-ANC/BSC soft handoff between a first access network controller and a second access network controller. In one embodiment, the one or more traffic flows include a traffic flow being categorized as either a first category of traffic or a second category of traffic. In another embodiment, the one or more traffic flows can be categorized as a combination of the first category of traffic and the second category of traffic. In yet another embodiment, the one or more traffic flows may include a third category of traffic in addition to either the first category of traffic or the second category of traffic or both the first category and the second category of traffic.

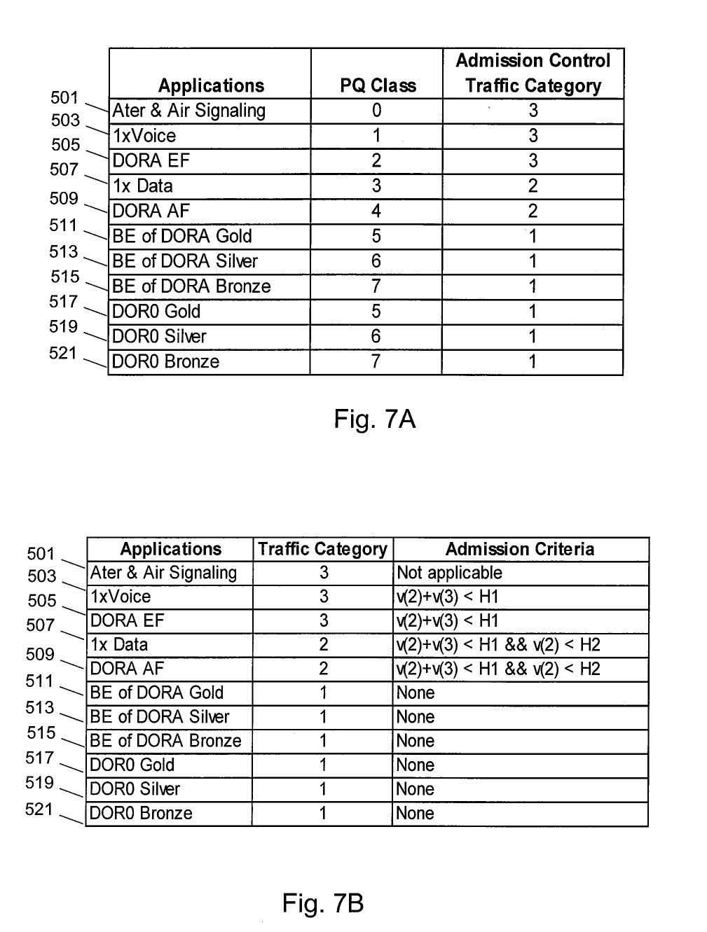

FIG. 7A is a table showing exemplary lists of flow applications of inter-AN soft handoff and corresponding priority queue classes according to an embodiment of the present invention. This table is merely an example, which should not unduly limit the scope of the claims herein. One of ordinary skilled in the art would recognize many alternatives, variations, and modifications. For example, some of the one or more traffic flows, such as the flows 501, 503, and 505, may belong to the first category of traffic for the inter-AN soft handoff including EF type traffic, 1x voice traffic and network signaling. These traffic flows are denoted as Category 3 traffic in FIG. 7A. The Category 3 traffic is associated with high priority levels in their corresponding priority queues (respectively in Q0, Q1, and Q2 with descending priority order). In another example, some of the one or more traffic flows, such as the flows 507 and 508, may belong to the second category of traffic including AF type traffic and 1x data traffic in FIG. 7A. These traffic flows are denoted as Category 2 traffic which are associated with mid priority levels in their corresponding priority queues (respectively in Q3 and Q4). In yet another example, some of the one or more traffic flows, such as flows 511-521, may belong to the third category of traffic including BE type traffic associated with low priority levels in corresponding priority queues from Q5 to Q7 as denoted as Category 1 traffic in FIG. 7A.

The method 600, according to certain embodiments of the invention, is applied to handle the communications traffic that are associated with mid or high priority levels so that the transmission quality of service (QoS) can be ensured for those communication applications. The QoS is considered through an admission control of traffic flows by setting corresponding admission criteria for each flow.

At the process 605, the method 600 is to measure a first predicted link utilization and a second predicted link utilization on the inter-AN link. In one embodiment, the link utilization refers to a quantity of data being transmitted on the link per unit time and unit link capacity. In another embodiment, the link utilization on the outbound transmission relative to an link interface board is measured per category of traffic and only for the first and second categories of traffic with high and mid level priority levels. In yet another embodiment, the predicted link utilization includes a raw link utilization measured at a particular time period plus a non-negative predicted increment between two subsequent measurements.

As an example, on the data link layer, the raw link utilization on an inter-ANC/BSC link from ANC/BSC i to ANC/BSC j can be defined as:
uᵢⱼ^{k}(n)=Nbits/(C·Tᵤₜᵢ)k=2, 3 (Eq. 1)

The variables in the above equation are defined as follows:

Nbits: total number of bits transmitted per Tᵤₜᵢ time interval, measured on the data link layer;

C: the link capacity. If a logical link is a bundle of multiple physical transmission links, the link capacity should be total capacity of those multiple physical links. For example, if an inter-ANC/BSC link consists of N E1 spans, then the link capacity should be 2.048 Mbps×N.

Tᵤₜᵢ: time interval of link utilization. The interface board measures the link utilization periodically, each per Tᵤₜᵢ time interval.

k: admission control traffic category, k=2, 3. The design only needs to measure high and mid priority traffic categories.

n: the iteration of measurement, each of Tᵤₜᵢ time interval.

To avoid the potential load surge in-between measurements, predicted increment is added to the raw link utilization before being used as the input of the admission control. Firstly, the increment between two subsequent measurements is calculated if there is a positive increment; otherwise, it is zero:
eᵢⱼ^{k}(n)=max{[uᵢⱼ^{k}(n)−uᵢⱼ^{k}(n−1)],0%} (Eq. 2)
Then the increment is exponentially weighted moving averaged to get the filtered increment:
gᵢⱼ^{k}(n)=w·gᵢⱼ^{k}(n−1)+(1w)·eᵢⱼ^{k}(n)(gᵢⱼ^{k}(0)=0) (Eq. 3)
where w is a weight factor (w<1). Finally, the filtered increment is added to the raw link measurement to get the predicted link utilization as the input of the admission control:
vᵢⱼ^{k}(n)=uᵢⱼ^{k}(n)+c·gᵢⱼ^{k}(n) (Eq 4)
where c is the scaling factor.

In a specific embodiment, a first predicted link utilization refers to a predicted link utilization v(3) for the Category 3 traffic. A second predicted link utilization refers to a predicted link utilization v(2) for the Category 2 traffic. In another specific embodiment, the predicted link utilization is calculated within the inter-AN interface board.

Referring back to FIG. 6, at the process 611, the method 600 is to determine whether one or more criteria is satisfied for controlling the admission of the one or more traffic flows associated with the inter-AN/BSS soft handoff request. In one embodiment, the one or more first criteria defines an input metric that can be implemented in an associated network controller. In another embodiment, the input metric on admission control is related to the first predicted link utilization and the second predicted link utilization obtained at the process 605. For example, as a new inter-AN soft handoff request is received by the ANC/BSC, a network controller component may be configured to check at least the first predicted link utilization for the first category of traffic and/or the second predicted link utilization for the second category of traffic currently on the corresponding inter-ANC/BSC link. In another embodiment, the process 611 is to determine if at least a first criterion is satisfied for the first category of traffic among the one or more traffic flows and at least a second criterion is satisfied for the second category of traffic among the one or more traffic flows.

FIG. 7B is a table showing exemplary admission criteria of corresponding traffic categories for a list of inter-AN soft handoff traffic flow applications shown in FIG. 7A according to an embodiment of the present invention. This table is merely an example, which should not unduly limit the scope of the claims herein. One of ordinary skilled in the art would recognize many alternatives, variations, and modifications. As shown in FIG. 7B, in a specific embodiment, if one traffic flow among the one or more traffic flows belongs to the first category of traffic, such as the Category 3 traffic flows 503 and 505, it is subject to the first criterion. The first criterion is to check if a sum of the first predicted link utilization and the second predicted link utilization v(3)+v(2) is less than a first predetermined threshold H1. Of course, other alternatives, variations, and modifications of the combinations of v(3) and v(2) may be used in definition of the first criterion. If one traffic flow among the one or more traffic flows in the request belongs to the second category of traffic, such as the Category 2 traffic flows 507 and 509, it is subject to the second criterion. The second criterion is to check if the first criterion is satisfied and additionally the second predicted link utilization v(2) is less than a second predetermined threshold H2, whereby H2 is less than H1. Of course, the second criterion can be defined with other alternatives, variations, and modifications.

In another specific embodiment, for a multi-flow applications, each request for transmission can have multiple traffic flows wherein admission controls need to verify all flow applications. If a multi-flow application includes both the first category of traffic and the second category of traffic, for example a Category 3 traffic flow 505 and a Category 2 traffic flow 509, the process 611 of the method 600 is to check the first criterion is satisfied for the first category of traffic and the second criterion is satisfied for the second category of traffic. In another example, for a multi-flow application including both the first category of traffic and the third category of traffic (such as a Category 3 traffic flow 505 and a Category 1 traffic flow 511), the process 611 of the method 600 is to check only the first criterion is satisfied for the first category of traffic. Yet in another example, for a multi-flow application including both the second category of traffic and the third category of traffic (such as a Category 2 traffic flow 509 and a Category 1 traffic flow 511), the process 611 of the method 600 is to check the second criterion is satisfied for the second category of traffic, wherein the first criterion is also required to be satisfied.

Referring back to FIG. 6 at the process 615, the method 600 is to admit the one or more traffic flows associated with the request for transmission after both the first criterion and the second criterion have been checked to be satisfied. As shown in FIG. 7B, the traffic flow associated with network signaling such as Ater&Air Signaling in priority queue Q0 having the highest priority level is not subject to the admission control. It is a kind of flow that will always be handled first on the inter-AN link. Additionally, no admission criterion is set for the traffic flow belonging to the third category of traffic (such as Category 1 traffic flows 511-521) which is associated with low priority queue from Q5 to Q7. These types of traffic flows, once admitted, will be transmitted through the inter-AN link based on a best-effort scheduling scheme and may be subject to a congestion control for corresponding queues. More detail description regarding the control of the best-effort scheduling traffic will be found in the specification below.

At the process 621, the method of 600 is to reject the request for transmission if either the first criterion or the second criterion or both is not satisfied at the process 611. For example, for a multi-flow application, if any one flow among the multiple flows corresponds to either Category 3 traffic or Category 2 traffic, but either the first criterion or the second criterion is determined to be not satisfied, all traffic flows in this multi-flow application can not be admitted.

The method of 600 for controlling admission of communications traffic into the inter-AN link can be applied to many wireless multi-media applications. Particularly it is capable of providing QoS transmission for inter-AN/BSS soft handoff request in CDMA2000 EVDO (or EVDV) or 1x RTT cellular networks. For example, the admission control can be triggered in following cases.

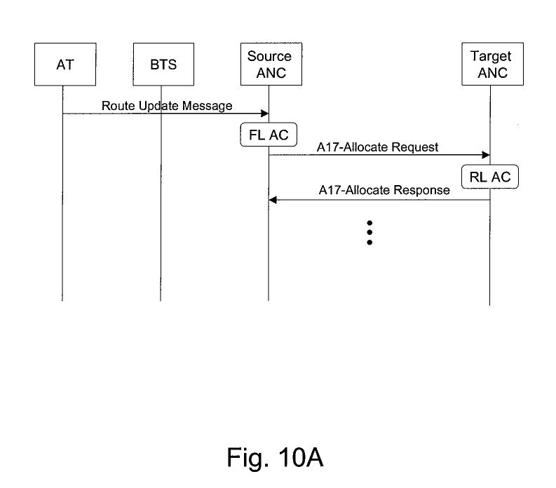

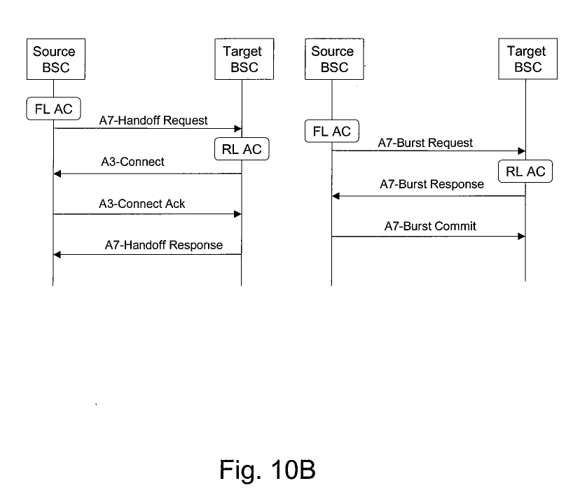

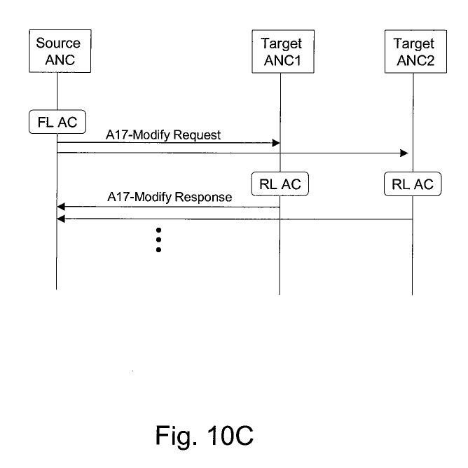

FIG. 10A is a simplified diagram illustrating a case of DO inter-ANC soft handoff in which admission controls may be triggered between a source ANC and a target ANC according to an embodiment of the present invention. This diagram is merely an example, which should not unduly limit the scope of the claims herein. One of ordinary skilled in the art would recognize many alternatives, variations, and modifications. In the case, an DO inter-ANC soft handoff is initiated for Access Terminal (AT) to move from one access network to another access network. As shown in FIG. 10A, a Source ANC receives a Route Update Message from AT via a Base Transmit Station (BTS). The message includes the request for transmission one or more traffic flows from the Source ANC to a Target ANC. According to an embodiment, a forward link admission control is triggered before the Source ANC sends an A17-Allocate Request message to the Target ANC. Thus, the method 600 is applied for controlling the admission of associated traffic flows from the Source ANC to the Target ANC. Additionally, according to another embodiment, a reverse link admission control is triggered after the Target ANC receives the A17-Allocate Request. Then the method 600 is applied for controlling admission of associated traffic flows including an A17-Allocate Response and other subsequent traffic flows from the Target ANC to the Source ANC.

FIG. 10B is a simplified diagram illustrating a case of 1x inter-BSC soft handoff in which admission controls may be triggered between a source BSC and a target BSC according to an embodiment of the present invention. This diagram is merely an example, which should not unduly limit the scope of the claims herein. One of ordinary skilled in the art would recognize many alternatives, variations, and modifications. In this case, an 1x inter-BSC soft handoff is involved. As shown in FIG. 10B, according to one embodiment, a forward link admission control is triggered before a Source BSC sends an A7-Handoff Request message or an A7-Burst Request message to a Target BSC. The method 600 is applied for controlling admission of associated traffic flows, in one example including an A3-Connect Ack. message or in another example including an A7-Burst Commit message, from the Source BSC to the Target BSC.

According to another embodiment, a reverse link admission control is triggered after the Target BSC receives the A7-Handoff Request or the A7-Burst Request. The method 600 thus is applied for controlling the admission of traffic flows associated with the soft handoff. The reverse link traffic flows, in one example, may include an A3-Connect message and an A7-Handoff Response message and subsequent flow applications from the Target BSC to the Source BSC. In another example, the reverse link traffic flows may include an A7-Burst Response message and subsequent flow applications from the Target BSC to the Source BSC.

FIG. 10C is a simplified diagram illustrating a case of adding a new flow to an existing DO inter-ANC soft handoff in which admission controls may be triggered between a source ANC and a target ANC according to an embodiment of the present invention. This diagram is merely an example, which should not unduly limit the scope of the claims herein. One of ordinary skilled in the art would recognize many alternatives, variations, and modifications. In this case, as shown in FIG. 10C, a forward link admission control is triggered before a Source ANC sends an A17-Modify Request message to a first Target ANC. In one example, the new flow is added to the forward link transmission from the Source ANC to a second Target ANC. Additionally, two reverse link admission control is triggered on two inter-ANC links. In one example, after the first Target ANC receives the A17-Modify Request from the Source ANC, the first Target ANC performs the admission control for one or more traffic flows including an A17-Modify Response message. In another example, the second Target ANC performs a admission control for one or more return traffic flows after receiving the new flow from the Source ANC.

Certain embodiments of the present invention provide a method for controlling congestion of communications traffic on an inter-AN link. The method includes admitting at least one traffic flow for transmission on an inter-AN link from a first access network controller to a second access network controller. The traffic flow is transmitted from a priority queue. The method further includes determining a queue length for the priority queue on the inter-AN link and processing information associated with the queue length. Additionally, the method includes determining whether the priority queue is in a congestion state based on at least information associated with the queue length. If the priority queue is determined in the congestion state, the method includes determining one or more traffic flows sent from one or more sources to the priority queue at one or more data rates respectively. The method further includes sending a congestion indication message for the priority queue to the one or more sources.

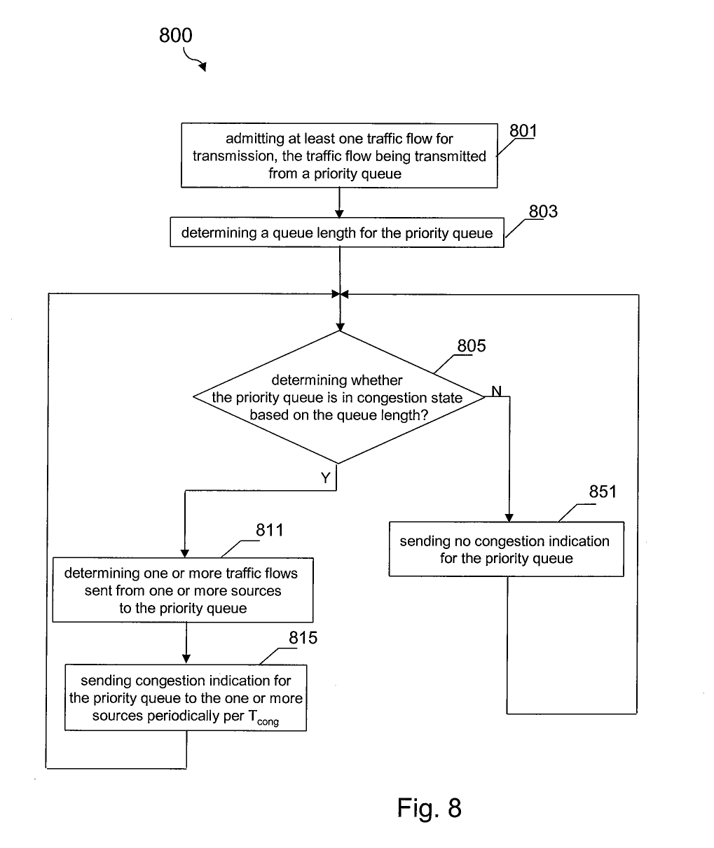

FIG. 8 is a flowchart illustrating a method for controlling congestion of communications traffic on an inter-AN link according to an embodiment of the present invention. This diagram is merely an example, which should not unduly limit the scope of the claims herein. The method 800 includes the following processes:

1. Process 801 for admitting at least one traffic flow for transmission on an inter-AN link, each being transmitted from a best-effort priority queue with a corresponding rate;

2. Process 803 for determining a queue length for the priority queue;

3. Process 805 for determining whether a priority queue is in a congestion state based on a queue length;

4. Process 811 for determining one or more traffic flows sent from one or more sources to the priority queue, if the priority queue is determined to be in the congestion state in the process 805;

5. Process 815 for sending a congestion indication for the priority queue to the one or more sources periodically per a time period T_{cong}; and

6. Process 851 for sending no congestion indication for the queue, if the priority queue is determined to be not in the congestion state in the process 805.

The above sequence of processes provides a method according to an embodiment of the present invention. Other alternatives can also be provided where processes are added, one or more processes removed, or one or more processes are provided in a different sequence without departing from the scope of the claims herein. Further detail of the present invention can be found throughout the present specification and more particularly below.

At the process 801, at least one traffic flow has been admitted for transmission on the inter-AN link. The traffic flow is transmitted from a priority queue. In one embodiment, the priority queue is a best-effort (BE) scheduled priority queue, for example, one of the low priority level queues Q5 to Q7. In one embodiment, one or more traffic flows may be transmitted from the same priority queue. For example, a BE of DORA Gold traffic and a DOR0 Gold are all transmitted from Q5 priority queue. Each traffic flow corresponds to a data rate that is adjustable by corresponding source for the traffic flow. In another embodiment, a data rate for one BE traffic flow may be the same or different from the data rate of another BE traffic flow on the same inter-AN link.

At the process 803, the method 800 is to determine a queue length for the priority queue on the inter-AN link. The queue length refers to a data packet size for the particular queue in transmission. At the process 803, a network controller component including an inter-An interface board is configured to monitor the queue length of three low priority level queues that buffer BE type data packets and determine whether control is needed for those traffic. In one embodiment, the queue length may be obtained periodically per a time period. For example, the time period is T_{cong}. In another embodiment, the queue length may be an averaged data packet size within T_{cong}. In yet another embodiment, the queue length is determined by the inter-AN interface board.

At the process 805, the method 800 is to determine whether a priority queue is in congestion state based on the queue length. The process 805 is an iterative process. In one embodiment, the BE type traffic is always allowed for transmission on the inter-AN link but without fully guarantee on QoS. In other words, if too many BE traffic flows are using a same queue, it may causes communication traffic congestion due to the link bandwidth limitation. Congestion control is necessary to reduce the incoming data rate of BE type flow applications into the queue during congestion. In another embodiment, a queue being in a congestion state is determined by one or more predetermined criteria related to the queue length for corresponding queue.

In a specific embodiment, the inter-AN interface board periodically per T_{cong} monitors the queue length of each of three priority queues denoted by Qi, i=5, 6, 7. When the queue is normal, the inter-AN interface board does not broadcast regarding the traffic congestion but to continue to monitor the queue length at subsequent time periods of T_{cong}. For example, the queue length is a moving averaged value within the current time period of T_{cong}. In one embodiment, as soon as the queue length is greater than or equal to a first (high) threshold for corresponding queue at one of time period, the queue is detected to be in a congestion state. In another embodiment, as long as the queue length is not less than a second (lower) threshold for corresponding queue at any subsequent time period of T_{cong}, the queue is determined to be still in or not out of the congestion state. In an alternate embodiment, if the queue length is less than the first threshold for corresponding queue at the first time period of T_{cong}, indicating the queue is normal, or if the queue length is detected to be less than the second threshold for corresponding queue at any subsequent timer periods of T_{cong}, the queue is determined to be out of the congestion state. In a specific embodiment, comparing the queue length with the first or second threshold is performed by the inter-AN interface board.

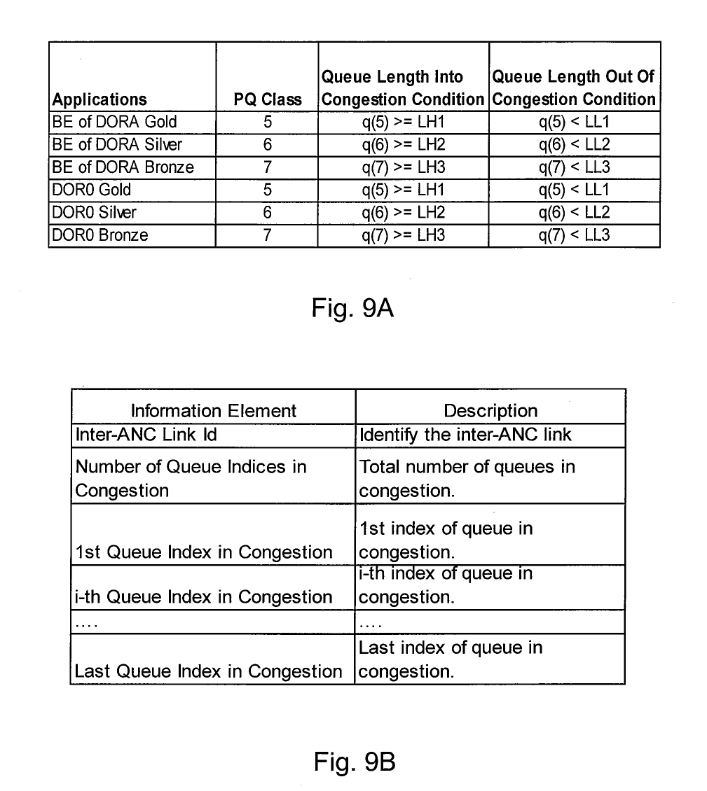

FIG. 9A is a table showing examples of a list of traffic flow applications subject to congestion control and the corresponding congestion conditions for each queue class according to an embodiment of the present invention. This diagram is merely an example, which should not unduly limit the scope of the claims herein. One of ordinary skilled in the art would recognize many alternatives, variations, and modifications. As shown in FIG. 9A, for a list of BE type traffic flow applications, the priority levels (PQ class) are denoted such as 5, 6, or 7. Correspondingly the queue length for those queues are denoted as q(5), q(6) and q(7). As soon as the queue length q(i), i=5, 6, 7, is detected to be greater than or equal to a high threshold LHi, i=5, 6, 7, the queue is determined to be in congestion condition. As long as the queue length q(i), i=5, 6, 7, is detected to be smaller than a low threshold LLi, i=5, 6, 7, the queue is determined to be out of congestion condition.

Referring back to FIG. 8, at the process 811, the method 800 is to determine the one or more traffic flows sent from one or more sources to corresponding queue if the queue is determined to be in the congestion state (at the process 805). In one embodiment, as shown in FIG. 9A, there may be more than one traffic flows sent to a same queue for transmission. For example, both BE of DORA Silver traffic and DORO Silver traffic use Q6.

At the process 815, the method 800 is to send a congestion indication message for the queue periodically per the time period of T_{cong} to the determined one or more sources for corresponding one or more traffic flows sent to the queue in the congestion state. In one embodiment, once the queue is detected in the congestion state or not out of the congestion state, the process 815 is executed to broadcast a congestion indication message periodically per T_{cong}. The congestion indication message indicates which priority queue is in the congestion state (within the corresponding time period of the T_{cong}). In another embodiment, the congestion indication message is sent from a network controller component including an inter-AN interface board to one of internal data processing unit (DPU) boards associated with the one or more sources for corresponding one or more traffic flows. In one example, the congestion indication message is sent by the inter-AN interface board via a broadcasting. In another example, the DPU board configured to receive the congestion indication message resides on a source ANC capable of managing both forward link or reverse link traffic flows. Of course, there are many alternatives, variations, or modifications.

FIG. 9B is a table showing exemplary information elements of a congestion indication message broadcasted by the network controller component to a source of one or more traffic flows according to an embodiment of the present invention. This diagram is merely an example, which should not unduly limit the scope of the claims herein. One of ordinary skilled in the art would recognize many alternatives, variations, and modifications. As shown in FIG. 9B, the message indicates a queue index of the queues in congestion. In this example, because only queues related to Gold, Silver, and Bronze type flow applications are subject to congestion control, there are at most three queue indices in congestion, i.e., Q5, Q6, and Q7. For example, in case there are two queues, Gold and Silver, in congestion, the message should have two indices: 5 and 6.

As the congestion indication message is broadcasted by the network controller component, the one or more sources for corresponding one or more traffic flows may reduce data rates to sent all corresponding one or more traffic flows to the congested queue in response to the congestion indication message. In one embodiment, with congestion control being effective, for example by implementing a firmware applying the method 800, the DPU board associated with a access network controller (ANC or BSC) is able to reduce the data rate of corresponding traffic flows. In another embodiment, because there may be more than one traffic flows using the queue in congestion state, then the data rates for all the corresponding traffic flows will be reduced. In yet another embodiment, the process 805 of the method 800 is performed iteratively at a subsequent time period of T_{cong} to continue determining the queue length, and so on. Subsequently at every iteration step the DPU board may further reduce the data rates of corresponding traffic flows if the process 805 determines that the queue is still in the congestion state. The lower data rate at every iteration results in less quantity of incoming data within each time period T_{cong} being buffered into the queue.

In one embodiment, one rate reduction algorithm can be applied as follows. When the DPU board receives a congestion indication message on a particular queue, it reduces forward link data rate of the flows using the queue that congested the inter-AN link. For example, if the congestion indication has shown queue Q5 in congestion on the inter-AN link, then the DPU board will reduce the data rate of any flow sent to the Q5 such as Gold user's BE flow including BE of DORA Gold flow and DORO Gold flow. In a specific embodiment, the rate reduction is realized by multiplying a rate-discount factor. By denoting a rate-discount factor at iteration n as dₙ, if a congestion indication is received per T_{cong} the rate-discount factor can be iteratively represented as:
dₙ=max{0%,dₙ₋₁×a},
assuming d₀=100% initially and a is constant less than 1. Whenever a rate discount factor is less than 100%, the data rate is reduced relative to the initial data rate determined by the source. Of course, the rate reduction algorithm shown here is merely an example, one of ordinary skilled would recognize many alternatives, variations, and modifications.

Referring to FIG. 8, alternatively, if the priority queue is detected at the process 805 to be out of the congestion state or initially not in the congestion state at all, the method 800 starts to perform the process 851. At the process 851, the method 800 is to send no congestion indication message. In one embodiment, the inter-AN interface board sends no congestion message for any queue if any queue length is less than a first (high) threshold for corresponding queue at its first check after it is admitted for transmission with assigned BE schedule. The method 800 then returns to the process 805 iteratively to further determine whether any priority queue is in congestion at any subsequent time period of T_{cong}. In another embodiment, if at one of later time period of T_{cong} the queue length of a once congested queue has been less than a second (lower) threshold, the inter-AN interface board may stop sending the congestion indication message. For example, the reduced data rate for those traffic flows using the congested queue results in less quantity of incoming data being buffered into the queue and on-going flow transmission results in a gradually drop of the queue length. As soon as the queue length drops below the second threshold, the queue is out of the congestion state and the inter-AN interface board stops broadcasting congestion indication message.

Without the broadcasting of congestion indication message, the one or more sources then will not receive the message. After a second time period of T_{off} (where T_{off}>T_{cong}) without receiving the congestion indication message the DPU board may increase the data rate for corresponding traffic flows sending to the priority queue from a reduced level back to a higher level. In one embodiment, at each subsequent iterative time period of T_{off}, if queue is determined by the process 805 to be out of congestion state, the data rates for corresponding traffic flows will be increased approaching to the initial rates set by the corresponding sources. That the time T_{off} is longer than the time T_{cong} is designed for ensuring that the congestion indication message is not lost. In a specific embodiment, if there is no congestion indication is received per T_{off} the rate discount factor can be iteratively represented as:
dₙ=min{100%,dₙ₋₁+b},
where d₀=100% initially and b is a constant. In this case, a rate-discount factor is greater at each iteration and the data rate at most may be recovered to 100% the initial level determined by the source. Of course, the rate increasing algorithm shown here is merely an example, one of ordinary skilled would recognize many alternatives, variations, and modifications.

According to certain embodiments, the method 800 for controlling the congestion of BE type traffic flows on an inter-AN link will be continuously applied for each of BE type traffic flows by monitoring the queue length iteratively to check if congestion control is needed until the transmission of the flow is finished.

According to certain embodiments, a method for controlling communications traffic on an inter-AN link includes receiving a request for transmission of a traffic flow through an inter-AN link between a first network controller and a second network controller. Additionally, the method includes determining a priority queue associated with the traffic flow. The priority queue corresponds to either one of a first plurality of priority levels or one of a second plurality of priority levels. Each of the first plurality of priority levels is higher than each of the second plurality of priority levels. If the priority queue corresponds to the one of the first plurality of priority levels, the method further includes determining whether one or more predetermined criteria for the traffic flow is satisfied. Moreover, if the one or more predetermined criteria is satisfied, the method includes admitting the traffic flow, storing information associated with the traffic flow in the queue, and transmitting information associated with the traffic flow from the queue based on at least a strict priority process. If the queue corresponds to the one of the second plurality of priority levels, the method further includes admitting the traffic flow, storing information associated with the traffic flow in the queue, and transmitting information associated with the traffic flow from the queue based on at least an arbitrated priority process.

According to alternative embodiments, a method of controlling communications traffic on an inter-AN link includes receiving a request for transmission of a first plurality of traffic flows through an inter-AN link from a first network controller to a second network controller. Additionally, the method includes grouping the first plurality of traffic flows into at least a second plurality of traffic flows and a third plurality of traffic flows. The second plurality of traffic flows is associated with a first group of queues corresponding to a first plurality of priority levels respectively. The third plurality of traffic flows is associated with a second group of queues corresponding to a second plurality of priority levels respectively. Each of the first plurality of priority levels is higher than each of the second plurality of priority levels. The method further includes determining whether one or more predetermined criteria are satisfied for the first plurality of traffic flows satisfies. If the one or more predetermined criteria are satisfied, the method further includes admitting the first plurality of traffic flows, storing information associated with the second plurality of traffic flows in the first group of queues, storing information associated with the third plurality of traffic flows in the second group of queues, moreover, the method includes transmitting information associated with the second plurality of traffic flows from the first group of queues based on at least a strict priority process and transmitting information associated with the third plurality of traffic flows from the second group of queues based on at least an arbitrated priority process.

In an embodiment, the method of determining whether one or more predetermined criteria are satisfied for the first plurality of traffic flows includes determining whether the one or more predetermined criteria are satisfied for the second plurality of traffic flows. If the one or more predetermined criteria are determined to be satisfied for the second plurality of traffic flows, the method determines that the one or more predetermined criteria are satisfied for the first plurality of traffic flows.

In another embodiment, the method of determining whether the one or more predetermined criteria are satisfied for the second plurality of traffic flows further includes determining whether corresponding one of the one or more predetermined criteria is satisfied for each of the second plurality of traffic flows. Only if the corresponding one of the one or more predetermined criteria is determined to be satisfied for each of the second plurality of traffic flows, the method determines that the one or more predetermined criteria are satisfied for the second plurality of traffic flows.

According to an alternative embodiment, the invention provides a system for controlling communications traffic on an inter-AN link. The system includes a network controller component that is configured to receive a request for transmission of a traffic flow through an inter-AN link and determine a priority queue associated with the traffic flow. The priority queue corresponds to either one of a first plurality of priority levels or one of a second plurality of priority levels. Each of the first plurality of priority levels is higher than each of the second plurality of priority levels. If the priority queue corresponds to the one of the first plurality of priority levels, the network controller component is further configured to determine whether one or more predetermined criteria for the traffic flow is satisfied. If the one or more predetermined criteria is satisfied, the network controller component further is configured to admit the traffic flow, store information associated with the traffic flow in the queue, and transmit information associated with the traffic flow from the queue based on at least a strict priority process. If the priority queue corresponds to the one of the second plurality of priority levels, the network controller component further is configured to admit the traffic flow, store information associated with the traffic flow in the queue, and transmit information associated with the traffic flow from the queue based on at least an arbitrated priority process. For example, the system for controlling communications traffic on an inter-AN link has been implemented in accordance to one or more of FIGS. 2-9 as shown in this specification. In another example, the system may be applied in the cases shown in FIGS. 10A, 10B, and/or 10C for admission control.

According to another embodiment, the invention provides a system of controlling communications traffic on an inter-AN link. The system includes a network controller component configured to receive a request for transmission of a first plurality of traffic flows through an inter-AN link and group the first plurality of traffic flows into at least a second plurality of traffic flows and a third plurality of traffic flows. The second plurality of traffic flows is associated with a first group of queues corresponding to a first plurality of priority levels respectively and the third plurality of traffic flows is associated with a second group of queues corresponding to a second plurality of priority levels respectively. Each of the first plurality of priority levels is higher than each of the second plurality of priority levels. additionally, the network controller component is configured to determine whether one or more predetermined criteria are satisfied for the first plurality of traffic flows satisfies. If the one or more predetermined criteria are satisfied, the network controller component is configured to admit the first plurality of traffic flows, store information associated with the second plurality of traffic flows in the first group of queues, and store information associated with the third plurality of traffic flows in the second group of queues. Moreover, the network controller component is configured to transmit information associated with the second plurality of traffic flows from the first group of queues based on at least a strict priority process and transmit information associated with the third plurality of traffic flows from the second group of queues based on at least an arbitrated priority process. For example, the system for controlling communications traffic on an inter-AN link has been implemented in accordance to one or more of FIGS. 2-9 as shown in this specification. In another example, the system may be applied in the cases shown in FIGS. 10A, 10B, and/or 10C for admission control.

According to yet another embodiment, the invention provides a system for controlling admission of communications traffic to an inter-AN link. The system includes a network controller component configured to receive a request for transmission of one or more traffic flows through an inter-AN link. The one or more traffic flows includes a first traffic flow corresponding to a first category of traffic selected from a plurality of categories of traffics. The network controller component processes information associated with the first category of traffic and determines a first predicted link utilization for the first category of traffic on the inter-AN link. Additionally, the network controller component processes information associated with the first predicted link utilization and determines whether the first category of traffic satisfies one or more first criteria based on at least information associated with the first predicted link utilization. The network controller component further is configured to reject the one or more traffic flows if the first category of traffic is determined not to satisfy the one or more first criteria. For example, the system for controlling admission of communications traffic to an inter-AN link has been implemented in accordance to one or more of FIGS. 2-7 as shown in this specification. In another example, the system may be applied in the cases shown in FIGS. 10A, 10B, and/or 10C.

According to yet still another embodiment, the invention provides a system for controlling congestion of communications traffic on an inter-AN link. The system includes a network controller component configured to admit at least one traffic flow for transmission on an inter-AN link, the traffic flow being transmitted from a priority queue and determine a queue length for the priority queue on the inter-AN link. The network controller component processes information associated with the queue length and determines whether the priority queue is in a congestion state based on at least information associated with the queue length. If the priority queue is determined in the congestion state, the network controller component determines one or more traffic flows sent from one or more sources to the priority queue at one or more data rates respectively and send a congestion indication message to the one or more sources; otherwise, the network controller component sends no congestion indication message. The system further includes an internal data processing unit (DPU) configured to reduce the one or more data rates for the one or more traffic flows sent to the priority queue iteratively per a first time period from an initial level in response to the congestion indicate message for the priority queue sent from the network controller component. The DPU board may increase the one or more data rates iteratively back to initial levels after a second time period without receiving the congestion indicate message for the priority queue. The second time period is longer than the first time period. For example, the system for controlling congestion of communications traffic on an inter-AN link has been implemented in accordance to one or more of FIGS. 2-5, 8, 9A, and 9B as shown in this specification.

The present invention has various advantages. Some embodiments provide quality of service (QoS) to the inter-access-network communication traffic. Certain embodiments provide a process of handling the inter-AN/BSS soft handoff for a mobile station or access terminal to switch between two wireless access networks in metropolitan networks including but not limiting the CDMA2000 EVDO, EVDV, or 1x RTT cellular networks. Some embodiments of the present invention provide priority queuing method to control the traffic in DO inter-ANC soft handoff, or inter-BSC soft handoff, or in adding a new flow to an existing DO inter-ANC soft handoff. For example, five priority queues are used for strict priority transmission scheduling for non-best-effort type of traffic flows with high and mid priority levels and three lower level priority queues for best-effort scheduled transmission. Certain embodiments of the present invention can control the admission of non-best-effort type traffic by utilizing an input metric related to the link utilization for providing guaranteed QoS for the application transmitted on the inter-AN link. Some embodiments of the present invention can provide congestion control for all admitted best-effort type traffic by properly adjust their data rates based on the congestion condition of corresponding queues. Other embodiments of the present invention provide a system for controlling the communication traffic including inter-AN/BSS soft handoff on an inter-AN link with quality of service.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for controlling communications traffic on an inter-access-network (inter-AN) link, the method comprising:
receiving a request for transmission of a traffic flow through an inter-AN link between a first network controller and a second network controller;
determining a priority queue associated with the traffic flow, the priority queue corresponding to either one of a first plurality of priority levels or one of a second plurality of priority levels, each of the first plurality of priority levels being higher than each of the second plurality of priority levels;
if the priority queue corresponds to the one of the first plurality of priority levels,
determining whether one or more predetermined criteria for the traffic flow is satisfied;
if the one or more predetermined criteria is satisfied,
admitting the traffic flow;
storing information associated with the traffic flow in the queue;
transmitting information associated with the traffic flow from the queue based on at least a strict priority process;
if the queue corresponds to the one of the second plurality of priority levels,
admitting the traffic flow;
storing information associated with the traffic flow in the queue;
transmitting information associated with the traffic flow from the queue based on at least an arbitrated priority process.

2. The method of claim 1 further comprising rejecting the request for transmission if the queue corresponds to the one of the first plurality of priority levels and if the one or more predetermined criteria for the traffic flow is not satisfied.

3. The method of claim 1 wherein the strict priority process is a transmission scheduling scheme for corresponding queue on the inter-AN link in a strict transmission order with descending priority level from a highest level to a lowest level.

4. The method of claim 1 wherein the arbitrated priority process is a transmission scheduling scheme for corresponding queue on the inter-AN link with an allocation of transmission time determined by a best-effort scheduling algorithm including Weighted Round Robin.

5. The method of claim 1 wherein the inter-AN link between the first network controller and the second network controller comprises a logic link between two Data Optimized Access Network Controllers (DO ANC) or two Base Station Subsystem Controllers (BSC).

6. The method of claim 5 wherein the logic link comprises one or more physical transmission links.

7. The method of claim 1 wherein the traffic flow on the inter-AN link is at least associated with a DO inter-ANC soft handoff, or an 1x inter-BSC soft handoff, and a new flow added to an existing DO inter-ANC soft handoff.

8. The method of claim 1 wherein the traffic flow being associated with a queue having one of first plurality of priority levels comprises at least one of Assured Forwarding type of traffic, 1x data traffic, Expedited Forwarding type of traffic, 1x voice traffic, or inter-AN signaling.

9. The method of claim 1 wherein the traffic flow being associated with a queue having one of second plurality of priority levels comprises a best-effort (BE) type of traffic including one of DORA Gold, DORA silver, DORA Bronze, DORO Gold, DORO Silver, and DORO Bronze type applications.

10. A method of controlling communications traffic on an inter-access-network (inter-AN) link, the method comprising:
receiving a request for transmission of a first plurality of traffic flows through an inter-AN link from a first network controller to a second network controller;
grouping the first plurality of traffic flows into at least a second plurality of traffic flows and a third plurality of traffic flows, the second plurality of traffic flows being associated with a first group of queues corresponding to a first plurality of priority levels respectively, the third plurality of traffic flows being associated with a second group of queues corresponding to a second plurality of priority levels respectively, each of the first plurality of priority levels being higher than each of the second plurality of priority levels;
determining whether one or more predetermined criteria are satisfied for the first plurality of traffic flows satisfies;
if the one or more predetermined criteria are satisfied,
admitting the first plurality of traffic flows;
storing information associated with the second plurality of traffic flows in the first group of queues;
storing information associated with the third plurality of traffic flows in the second group of queues;
transmitting information associated with the second plurality of traffic flows from the first group of queues based on at least a strict priority process;
transmitting information associated with the third plurality of traffic flows from the second group of queues based on at least an arbitrated priority process.

11. The method of claim 10 wherein the determining whether the one or more predetermined criteria are satisfied for first plurality of traffic flows comprises:
determining whether the one or more predetermined criteria are satisfied for the second plurality of traffic flows;
if the one or more predetermined criteria are determined to be satisfied for the second plurality of traffic flows, determining that the one or more predetermined criteria are satisfied for the first plurality of traffic flows.

12. The method of claim 11 wherein the determining whether the one or more predetermined criteria are satisfied for the second plurality of traffic flows comprises:
determining whether corresponding one of the one or more predetermined criteria is satisfied for each of the second plurality of traffic flows;
only if the corresponding one of the one or more predetermined criteria is determined to be satisfied for each of the second plurality of traffic flows, determining that the one or more predetermined criteria are satisfied for the second plurality of traffic flows.

13. The method of claim 10 wherein the first network controller may be a source Access Network Controller/Base Station Controller (ANC/BSC) for forward link transmission of the first plurality of traffic flows or a target ANC/BSC for reverse link transmission of the first plurality of traffic flows.

14. The method of claim 10 wherein the transmitting information associated with the second plurality of traffic flows from the first group of queues based on at least a strict priority process comprising transmitting packets on the inter-AN link scheduled in a strict descending order of corresponding priority queues from a highest priority level to a lowest priority level.

15. The method of claim 10 wherein the transmitting information associated with the third plurality of traffic flows from the second group of queues based on at least an arbitrated priority process comprising scheduling transmission of corresponding queues on the inter-AN link with an allocation of transmission time determined by a best-effort scheduling algorithm including Weighted Round Robin.

16. The method of claim 15 wherein the transmitting information associated with the third plurality of traffic flows from the second group of queues further comprising:
transmitting each of the third plurality of traffic flows with a corresponding data rate;
determining whether each of the second group of queues is in a congestion state based on corresponding queue length;
if one or more the second group of queues is determined in the congestion state,
broadcasting a congestion indication message for corresponding one or more second group of queues.

17. The method of claim 10 wherein the request for transmission of the first plurality of traffic flows on the inter-AN link is at least associated with a DO inter-ANC soft handoff, or an 1x inter-BSC soft handoff, and adding a new flow to an existing DO inter-ANC soft handoff.

18. The method of claim 10 further comprising rejecting the request for transmission if the one or more predetermined criteria for the first plurality of traffic flows is not satisfied.

19. A method for controlling admission of communications traffic to an inter-access-network (inter-AN) link, the method comprising:
receiving a request for transmission of one or more traffic flows through an inter-AN link between a first network controller and a second network controller, the one or more traffic flows including a first traffic flow corresponding to a first category of traffic selected from a plurality of categories of traffics;
processing information associated with the first category of traffic;
determining a first predicted link utilization for the first category of traffic on the inter-AN link;
processing information associated with the first predicted link utilization;
determining whether the first category of traffic satisfies one or more first criteria based on at least information associated with the first predicted link utilization;
rejecting the one or more traffic flows if the first category of traffic is determined not to satisfy the one or more first criteria.

20. The method of claim 19 wherein the determining a first predicted link utilization includes:
measuring at least a first raw link utilization for the first category of traffic within a first time interval and a second raw link utilization for the first category of traffic within a second time interval; and
determining the first predicted link utilization within the second time interval based on at least information associated with the first raw link utilization and the second raw link utilization;
wherein the second time interval is equal to the first time interval and is a time period immediately sequential to the first time interval.

21. The method of claim 20 wherein the first raw link utilization for the first category of traffic is defined by a total number of bits transmitted per the first time interval and unit link capacity for the first category of traffic.

22. The method of claim 20 wherein the determining the first predicted link utilization further comprises:
calculating a raw increment defined as the difference between the second raw link utilization and the first link utilization;
obtaining an filtered increment by performing an exponentially moving average of the raw increment; and
adding the filtered increment to the second raw link utilization to obtain the first predicted link utilization within the second time interval.

23. The method of claim 19 wherein the plurality of categories of traffics includes the first category of traffic and a second category of traffic, the first category of traffic and the second category of traffic being different.

24. The method of claim 23, and further comprising:
processing information associated with the second category of traffic;
determining a second predicted link utilization for the second category of traffic on the inter-AN link;
processing information associated with the second predicted link utilization;
wherein the determining whether the first category of traffic satisfies one or more first criteria is performed based on at least information associated with the first predicted link utilization and the second predicted link utilization.

25. The method of claim 24 wherein the determining whether the first category of traffic satisfies one or more first criteria includes determining whether a sum of the first predicted link utilization and the second predicted link utilization is smaller than a first predetermined threshold.

26. The method of claim 24, and further comprising:
determining whether the second category of traffic satisfies one or more second criteria including determining whether a sum of the first predicted link utilization and the second predicted link utilization is smaller than a first predetermined threshold and the second predicted link utilization is smaller than a second predetermined threshold.

27. The method of claim 19 wherein the first category of traffic and the second category of traffic comprise one or more flows selected from Assured Forwarding (AF) type traffic, 1x data traffic, Expedited Forwarding (EF) type traffic, and 1x voice traffic.

28. The method of claim 19 wherein the request for transmission of one or more traffic flows comprises a request of data-optimized (DO) inter-access-network-controller (inter-ANC) soft handoff, a request of 1x inter-base-station-controller (inter-BSC) soft handoff, or a request of adding a new flow to an existing DO inter-ANC soft handoff.

29. A method for controlling congestion of communications traffic on an inter-AN link, the method comprising:
admitting at least one traffic flow for transmission on an inter-AN link from a first access network controller to a second access network controller, the traffic flow being transmitted from a priority queue;
determining a queue length for the priority queue on the inter-AN link;
processing information associated with the queue length;
determining whether the priority queue is in a congestion state based on at least information associated with the queue length;
if the priority queue is determined in the congestion state,
determining one or more traffic flows sent from one or more sources to the priority queue at one or more data rates respectively;
sending a congestion indication message for the priority queue to the one or more sources.

30. The method of claim 29 wherein the traffic flow being admitted for transmission is at least one of flow applications including DORA Gold, DORA Silver, DORA Bronze, DOR0 Gold, DOR0 Silver, and DORO Bronze that are scheduled using a best-effort scheduling algorithm.

31. The method of claim 29, and further comprising the one or more sources reduce the one or more data rates from one or more levels respectively in response to the congestion indication message by multiplicatively reducing a rate discount factor.

32. The method of claim 31, and further comprising the one or more sources increase the one or more data rates back to the one or more levels by additively increasing a rate discount factor if the priority queue is determined out of the congestion state.

33. The method of claim 29 wherein each of the one or more sources reduces or increases data rates via an internal data processing unit board associated with an access network controller capable of managing both forward link traffic flows and reverse link traffic flows.

34. The method of claim 29 wherein the priority queue is determined in the congestion state if the queue length is greater than or equal to a first threshold for corresponding priority queue at a first time period and if the queue length is no less than a second threshold for corresponding priority queue at any subsequent first time period, wherein the second threshold being smaller than the first threshold.

35. The method of claim 34 wherein the queue length is determined iteratively per the first time period.

36. A system for controlling communications traffic on an inter-access-network (inter-AN) link, the system comprising:
a network controller component configured to:
receive a request for transmission of a traffic flow through an inter-AN link;
determine a priority queue associated with the traffic flow, the priority queue corresponding to either one of a first plurality of priority levels or one of a second plurality of priority levels, each of the first plurality of priority levels being higher than each of the second plurality of priority levels;
if the priority queue corresponds to the one of the first plurality of priority levels,
determine whether one or more predetermined criteria for the traffic flow is satisfied;
if the one or more predetermined criteria is satisfied,
admit the traffic flow;
store information associated with the traffic flow in the queue;
transmit information associated with the traffic flow from the queue based on at least a strict priority process;
if the priority queue corresponds to the one of the second plurality of priority levels,
admit the traffic flow;
store information associated with the traffic flow in the queue;
transmit information associated with the traffic flow from the queue based on at least an arbitrated priority process.

37. A system of controlling communications traffic on an inter-AN link, the system comprising:
a network controller component configured to:
receive a request for transmission of a first plurality of traffic flows through an inter-AN link;
group the first plurality of traffic flows into at least a second plurality of traffic flows and a third plurality of traffic flows, the second plurality of traffic flows being associated with a first group of queues corresponding to a first plurality of priority levels respectively, the third plurality of traffic flows being associated with a second group of queues corresponding to a second plurality of priority levels respectively, each of the first plurality of priority levels being higher than each of the second plurality of priority levels;
determine whether one or more predetermined criteria are satisfied for the first plurality of traffic flows satisfies;
if the one or more predetermined criteria are satisfied,
admit the first plurality of traffic flows;
store information associated with the second plurality of traffic flows in the first group of queues;
store information associated with the third plurality of traffic flows in the second group of queues;
transmit information associated with the second plurality of traffic flows from the first group of queues based on at least a strict priority process;
transmit information associated with the third plurality of traffic flows from the second group of queues based on at least an arbitrated priority process.

38. A system for controlling admission of communications traffic to an inter-access-network (inter-AN) link, the system comprising:
a network controller component configured to:
receive a request for transmission of one or more traffic flows through an inter-AN link, the one or more traffic flows including a first traffic flow corresponding to a first category of traffic selected from a plurality of categories of traffics;
process information associated with the first category of traffic;
determine a first predicted link utilization for the first category of traffic on the inter-AN link;
process information associated with the first predicted link utilization;
determine whether the first category of traffic satisfies one or more first criteria based on at least information associated with the first predicted link utilization; and
reject the one or more traffic flows if the first category of traffic is determined not to satisfy the one or more first criteria.

39. A system for controlling congestion of communications traffic on an inter-AN link, the system comprising:
a network controller component configured to:
admit at least one traffic flow for transmission on an inter-AN link, the traffic flow being transmitted from a priority queue;
determine a queue length for the priority queue on the inter-AN link;
process information associated with the queue length;
determine whether the priority queue is in a congestion state based on at least information associated with the queue length;
if the priority queue is determined in the congestion state,
determine one or more traffic flows sent from one or more sources to the priority queue at one or more data rates respectively;
send a congestion indication message to the one or more sources;
otherwise, send no congestion indication message;
an internal data processing unit (DPU) configured to:
reduce the one or more data rates for the one or more traffic flows sent to the priority queue iteratively per a first time period from an initial level after receiving the congestion indicate message for the priority queue from the network controller component; or
increase the one or more data rates iteratively back to initial level after a second time period without receiving the congestion indicate message for the priority queue from the network controller component, wherein the second time period is longer than the first time period.
